(19) United States
(12) Patent Application Publication
(10) Pub. No.: US 2006/0095306 A1
(43) Pub. Date: May 4, 2006

(54) Market allocation design methods and systems

(75) Inventors: Roger A. Parker, Shoreline, WA (US); William Richard Cunliffe Lonsdale, Vancouver (CA); Zhengjie Zhang, Covington, WA (US)

Correspondence Address: BAKER & HOSTETLER LLP, Washington Square, Suite 1100, 1050 Connecticut Avenue, N.W., WASHINGTON, DC, 20036, US

(73) Assignee: The Boeing Company

(21) Appl. No.: 10/974,697

(22) Filed: Oct. 28, 2004

(51) Int. Cl. G06Q 10/00

(52) U.S. Cl. 705/7; 705/5

(57) ABSTRACT

Techniques for determining constrained market allocation for a travel network having a plurality of origin-destination market pairs include using a first device that computes constrained market allocation based on the capacity of at least a first leg of the travel network and the passenger utility of at least one path that includes the first leg.

### FIELD OF THE INVENTION

This invention relates to methods and systems for allocating market share for transportation systems having a plurality of terminals.

### BACKGROUND OF THE INVENTION

Over the last thirty years, various Airlines and other transportation services have struggled to more efficiently serve their traveling clientele and eliminate traveling problems. One particular problem that arises in the travel industry is the propensity to “overbook” a flight, which can lead to customer satisfaction issues and lost profits.

Overbooking and underbooking flights are issues that arise under market allocation. In the airline industry, a “market” can refer to a specific pair of terminals representing a travel origin and a travel destination, and “market allocation” can refer to the process of allocating consumer demand for a specific market pair to the various possible routes that serve that market. For example, in the transportation industry, San Jose, Calif. (an origin) and Nashville, Tenn. (a destination) can represent a market pair (or simply “a market”), with a prospective “market allocation” including a distribution of passengers among four separate paths: a direct flight from San Jose to Nashville, a flight having a stopover in Chicago, Ill., a flight having a stopover in Minneapolis, Minn. and a flight having a first stopover in both Chicago, Ill. and Baltimore, Md.

While the market allocation scenario above appears simple, the reality is that the various world-wide travel networks include hundreds of terminals, i.e., prospective origins and destinations, representing tens of thousands of markets and millions of potential origin-destination paths to consider. The problem worsens when two or more separate markets share common “legs”. For example, as discussed above, the San Jose-Nashville market may include Chicago-Baltimore leg. The Chicago-Baltimore leg, however, must be shared with the Chicago-Baltimore market, the San Jose-Baltimore market and numerous others.

As no “leg” of the transportation industry has infinite capacity to carry passengers, it should be appreciated that the problem of allocating consumer demand for a given market must take into consideration the allocation of consumer demand for a large number of other markets as well. While computers have provided an invaluable resource to solving the problem of allocating consumer demand, the reality is that scheduling problems, such as overbookings, continue to arise. Accordingly, new computer-based methods and systems related to reducing market allocation problems are desirable.

### SUMMARY OF THE INVENTION

In one aspect, a computer-based apparatus for determining constrained market allocation for a travel network having a plurality of origin-destination market pairs includes a first device that computes constrained market allocation based on the capacity of at least a first leg of the travel network and the passenger utility of at least one path that includes the first leg.

In a second aspect, a method for performing a constrained market allocation on a travel network having a plurality of origin-destination market pairs and wherein at least two origin-destination market pairs share a first common travel leg includes determining whether the first leg is over capacity, and performing the step of calculating demand adjustment factors for each market pair sharing the first leg to produce an adjusted value for the first leg if the first leg is over capacity.

In a third aspect, a method for determining a number of potential paths for an origin-destination market pair in a travel network includes forming a set of first paths based on the passenger utility of the first paths.

In a fourth aspect, a method for determining a set of desirable paths for an origin-destination market pair in a travel network includes forming a set of initial paths from a set of available paths for the origin-destination market pair, wherein the set of initial paths includes only two paths having the highest passenger utility of any of the available paths.

There has thus been outlined, rather broadly, certain embodiments of the invention in order that the detailed description thereof herein may be better understood, and in order that the present contribution to the art may be better appreciated. There are, of course, additional embodiments of the invention that will be described or referred to below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a device capable of generating origin-destination pairs for a travel market.

FIG. 2 depicts an exemplary travel market.

FIG. 3 depicts a path tree for the market of FIG. 2

FIG. 4 is a flowchart outlining an exemplary operation for scheduling programs.

FIG. 5 is a flowchart outlining a second exemplary operation for scheduling programs.

FIG. 6 is a flowchart outlining a third exemplary operation for scheduling programs.

FIG. 7 is a flowchart outlining a fourth exemplary operation for scheduling programs.

### DETAILED DESCRIPTION

The particular approach of the disclosed methods and systems includes a variety of novel elements designed to work together in such a way as to produce market allocation models that realistically portray real-world markets and produce itineraries for all of a travel service provider's customer base.

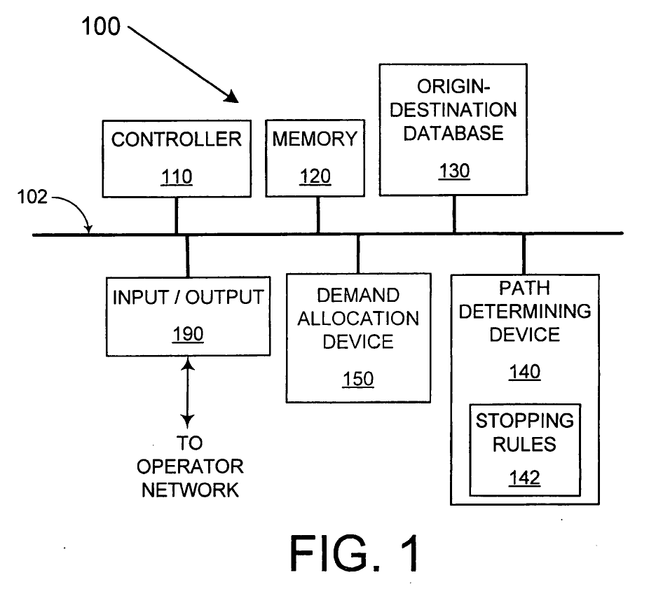

FIG. 1 is a scheduler 100 capable of generating such itineraries for a travel service provider, i.e., a “carrier”. As shown in FIG. 1, the exemplary scheduler includes a controller 110, a memory 120, an origin-destination database 130, a path-determining device 140 with library 142, a demand allocation device 150 and an input/output device 190. The above components 110-190 are coupled together by control/data bus 102.

Although the exemplary scheduler 100 of FIG. 1 uses a bussed architecture, it should be appreciated that any other architecture may be used as is well known to those of ordinary skill in the art.

It also should be appreciated that some of the above-listed components can take the form of software/firmware routines residing in memory 120 capable of being executed by the controller 110. More particularly, it should be understood that the functions of any or all of components 140-150 can be accomplished using object-oriented software, thus increasing portability, software stability and a host of other advantages not available with non-object-oriented software.

Still further, it should be understood that the functions of any or all of components 140-150 can be accomplished using separate processing systems networked together and that either or both of components 140-150 can include multiple processors working in series and/or parallel.

In operation, it should be appreciated that the exemplary scheduler 100 may need to generate a list of all origin-destination market pairs of interest to populate database 130 (or alternatively import one via input/out device 190). In various embodiments, it should be appreciated that such a database can be associated with airline hubs, bus depots, train stations or any other end-points or way-stations associated with a particular form or travel. However, it should also be appreciated that the methods and systems of the scheduler can also be applied to travel networks using multiple forms of travel, e.g., airlines and trains.

Returning to FIG. 1, once the origin-destination database 130 is populated, the path determining device 140 can access the origin-destination database 130 and generate a number of viable paths for each market pair.

An initial review of even a modest travel network of fifty airline terminals reveals that very quickly the number of possible paths between an origin-destination pair will explode. For example, there are easily thousands of possible ways to get from Seattle to New York in the US airline network. Many of them, of course, are ridiculous, as one doesn't usually don't go to New York by way of Warsaw or opt to take a dozen connecting flights. Accordingly, it should be appreciated that some reasonable criteria for eliminating unrealistic paths from consideration can be developed and described. For the purpose of this disclosure, such a criterion is called a “stopping rule”, and the connection generation process can be broken down to two phases—the creation of a potential connection, and its evaluation for “reasonableness” encompassed in any number of stopping rules.

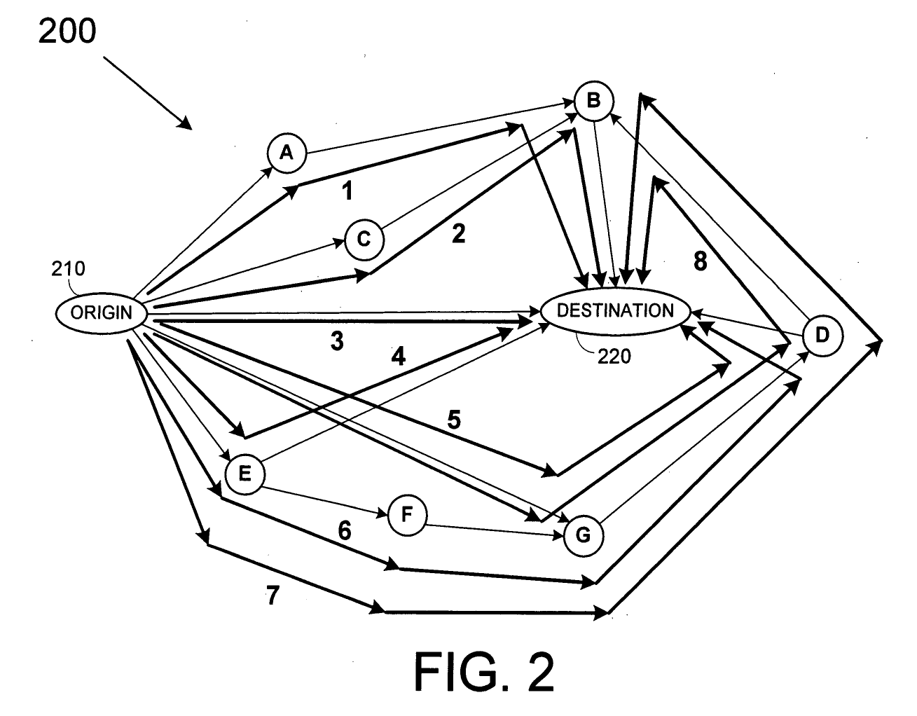

By way of example, consider the topology of FIG. 2, which depicts a travel network 200 capable of connecting an origin-destination market pair. As shown in FIG. 2, the travel network 200 includes an origin 210, a destination 220 and seven travel nodes A-G that together form paths 1-8. While it is literally possible to create an infinite number of paths to get from the origin 210 to the destination 220, the current paths in FIG. 2 are limited to paths which do not cross the same node twice. In this case, there are eight identified ways of getting from the origin to the destination wherein Path 3 is a direct non-stop route, Path 4 is a one-stop route, Path 1 is a two-stop route and so on.

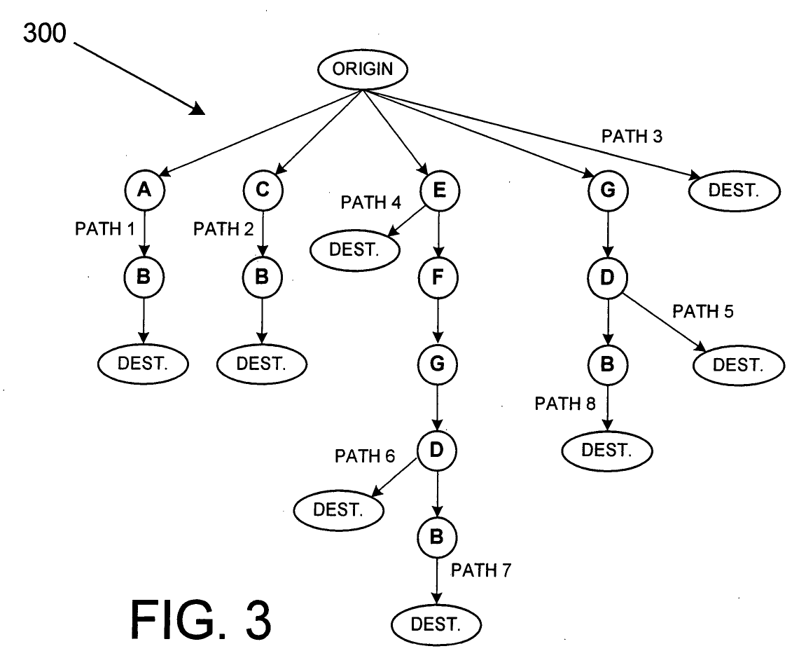

Returning to FIG. 1, the path-determining device 140 can first determine the available paths of a travel network, such as the one of FIG. 2. While any known or later developed approach can be implemented, the exemplary path-determining device 140 can use an approach known as a “depth-first” search. In this approach, each possible path is described as the branch of an inverted tree, and is generated as follows: a) from the origin, the path-determining device 140 can put all the possible non-stop travel nodes in some order; then b) go to the first non-stop travel nodes. If a travel node is the final destination, then there is a path and the path-determining device 140 can record it, and go to the next non-stop travel node; and c) if the travel nodes is not the final destination, then the path-determining device 140 can put all the travel nodes that are non-stops from this location in some order, and look at the first one of those; and d) if that travel node is the final destination, the path-determining device 140 can record it, and move on to the next node. The path-determining device 140 can continue in this way until all branches of the tree are explored, recording all the itineraries that connect the origin and destination and ignoring all the rest. FIG. 3 depicts such a path tree 300 capable of being generated from the travel network 200 of FIG. 2.

With FIG. 3 in mind, any number of stopping rules can be applied. For example, a first possible stopping rule can be: “No route which has more than two stops will be considered.” Under this rule, only paths 1, 2, 3, 4, and 5 are allowed, since 6, 7 and 8 have too many stops. If the rule were changed to permit only one stop, then only paths 3 and 4 are permitted. Other stopping possible stopping rules available to the path-determining device 140 can include some form of time duration or mileage limitation, such as some multiplier of the non-stop flight duration.

In addition to the variety of known principles of standard stopping rules, the exemplary path-determining device 140 can use a stopping rule that makes use of what is known as the passenger utility function. That is, the path-determining device 140 can stop path consideration when the utility of the path becomes so low as to be essentially of no value to the passenger and thus no one is expected to take that route. One embodiment of such a stopping rule is described by the pseudo-code below:

Load all travel nodes available from origin
For each travel node

Order all flights out of origin by passenger utility
Is the first travel node a final destination?

If Yes, then record path and consider next travel node
Hit stopping rule?

If Yes: Go to next travel node
If No:

Load all 2^{nd} order travel nodes from this
travel node
For each 2^{nd} order travel node

Order 2^{nd} order flights by passenger
utility
Is the final destination among 2^{nd} order
travel nodes?

If Yes: Record path; next destination
Hit stopping rule?

If Yes: Go To Next 2^{nd} order
travel node
If No:

Repeat for 3^{rd}, 4^{th} etc.
order travel nodes until
there are no more

Next 2^{nd} order travel node

Next travel node

This technique outlined in the pseudo-code above will always generate paths that will meet any stopping rule criterion. Unfortunately, if the stopping rule is very generous, it will allow most paths and the network will be too large. As a result, the execution of the technique may becomes an End of the Universe (EOU) problem in that it would take longer than the expected life of the universe to solve.

The underlying algorithm, however, is ideal for parallel processing since finding the connections for a particular origin-destination pair is independent of the other pairs in the case under study. Thus it should be appreciated that the path-determining device 140 can advantageously take the form of a multiprocessor-based device capable of generating connections on many origin-destination pairs simultaneously.

Returning to the pseudo-code above, it should be appreciated that one key aspect of the embedded algorithm is the stopping rule, which as stated above can be based on passenger utility. In general, a “passenger utility function” can be described as the desirability or likelihood that a passenger or group of passengers will prefer or use a particular travel path at a particular time. In various embodiments, one passenger utility function available to the path-determining device 140 is a “low resolution” utility function given by the formula of EQ. 1 below:
V(j)=β_{f} ln fⱼ+β_{d}dⱼ+β_{bd}dⱼ ln d_{b}+βₛsⱼ+βₘₒX_{mo,j}+β_{eo,j}X_{eo,j}+β_{md,j}X_{md,j}+β_{ed,j}X_{ed,j} (1)
where j is the path index, fⱼ the fare of path j, dⱼ the duration (travel time) of the path j, d_{b} the duration of a non-stop path, sⱼ the number of stops on path j, and X_{ma,j}, X_{ea,j}, X_{md,j} and X_{ed,j} are indicator variables denoting morning arrival, evening arrival, morning departure and evening departure, respectively.

In various embodiments, the β coefficients can be empirically derived parameters. However, the particular origin of these parameters may possibly vary as desired or otherwise required. Additionally, while the particular parametric model of EQ. 1 has been found to be of good utility, it should be appreciated that any form of passenger utility model can be used as may be found useful or advantageous. For example, in addition to any number of “low-resolution” parametric models, higher resolution parametric models may be use, stochastic models may be use, neural-based models may be used and so on. More detail about a particular embodiment of low and high-resolution models can be found in “Introduction to the Boeing Passenger Choice Model” by R. Parker attached in Appendix A below.

Continuing with operation, the path-determining device 140 can start with an arbitrary path, say path j, and compare it to a “perfect” path, denoted ρ, which can be defined as a non-stop service leaving and arriving at times which yield the highest utility as defined by V(ρ). The definition of probability for the Passenger Choice Model then can be described by EQ. 2 below:

$$\begin{matrix}Pr [ j \vert ρ ] = \frac{{ⅇ}^{V ( j )}}{{ⅇ}^{V ( ρ )} + {ⅇ}^{V ( j )}} \\ = \frac{1}{1 + {ⅇ}^{V ( ρ ) - V ( j )}}\end{matrix} \qquad ( 2 )$$

where Pr[j|ρ] is the probability of choosing flight j over the non-stop ideal flight ρ.

In various embodiments, the path-determining device 140 can apply a stopping rule whereby paths are eliminated when the probability of a passenger choosing it is too low. In one specific example, this can include any path for which the expected passenger demand is less than one. Thus, if N is the expected demand from the origin to the destination under study, then the rule can become “Eliminate any path j such that Pr[j|ρ] is less than 1/N. Thus EQ. 3 below can be derived:

$$\begin{matrix}Pr [ j \vert ρ ] = \frac{1}{1 + {ⅇ}^{V ( ρ ) - V ( j )}} < \frac{1}{N} \\ ⇒ 1 + {ⅇ}^{V ( ρ ) - V ( j )} > N \\ ⇒ V ( ρ ) - V ( j ) > ln ( N - 1 )\end{matrix} \qquad ( 3 )$$

To make the notation easier, one can define the function Q(ρ,j) as the difference between the utility of path ρ and the utility of path j to form EQ. 4 below:

$$\begin{matrix}Q ( ρ , j ) ≡ V ( ρ ) - V ( j ) \\ = {β}_{f} ln ( {f}_{ρ} - {f}_{j} ) + {β}_{d} ( {d}_{ρ} - {d}_{j} ) + {β}_{bd} ln {d}_{b} ( {d}_{ρ} - {d}_{j} ) + \\ {β}_{s} ( {s}_{ρ} - {s}_{j} ) + {β}_{mo} ( {X}_{mo , ρ} - {X}_{mo , j} ) + {β}_{eo} ( {X}_{eo , ρ} - {X}_{eo , j} ) + \\ {β}_{md} ( {X}_{md , ρ} - {X}_{md , j} ) + {β}_{ed , j} ( {X}_{ed , ρ} - {X}_{ed , j} ) .\end{matrix} \qquad ( 4 )$$

Using EQ. 4 as a basis, a path can be eliminated if
Q(ρ,j)>ln(N−1) (5)

Unfortunately, while using a stopping probability of 1/N is intellectually attractive, it may still be too generous for even small networks. Accordingly, in various embodiments the path-determining device 140 can optionally make this stopping rule more stringent by choosing an arbitrary probability P* as the stopping criterion, in which case the 1n(N−1) term in EQ. 6 becomes 1n(1/P*).

In still other embodiments, the path-determining device 140 can apply a variety of potentially more clever approaches to cutting the number of paths down, one which can also be more analytical than applying an arbitrary P* as the number of connections generated with even a relatively high value of P* can far exceed the demand for travel in an origin-destination pair. For example, the inventors of the disclosed methods and systems have determined that the number of reasonable paths, according to the utility stopping rule, can exceed the market demand by a factor of 25 or more. Given that the number of connections can have a dramatic effect on the execution time of a particular demand allocation algorithm, especially a constrained demand algorithm, further pruning of the useful paths can yield substantial performance benefits.

Accordingly, in various embodiments the path-determining device 140 can employ a “most useful alternative” approach that can dramatically reduce the number of paths to be considered for demand allocation.

Let ψ be the set of paths for an origin-destination created by the stopping rule in expression (5) above. By calculating the probability of each path in ψ considering all the other connecting paths in ψ, rather than compare path j to a (perhaps) theoretical perfect non-stop ρ, the general passenger choice probability can be expressed by EQ. 6 below:

$$\begin{matrix}{p}_{ψ} ≡ Pr [ ψ ] \\ = \frac{{ⅇ}^{V ( ψ )}}{{\sum }_{θ ∈ Ψ} {ⅇ}^{V ( θ )}} .\end{matrix} \qquad ( 6 )$$

Now by ordering the paths in ψ from high to low according to their respective probabilities p_{ψ}, one can denote the highest probability by p₁, then next by p₂, etc., to create the ordering of EQ. 7 below:
p₁≧p₂≧ . . . ≧p_{n(ψ)} (7)
where n(ψ) is the number of paths in ψ, and the expected number of passengers that would fly on path ψ is simply Np_{ψ}.

The advantage to creating an order according to EQ. 7 includes the realization that, for any of p where Np first falls below 1, every path after that one will also have an expected load of less than 1. As it may not be sensible to include such paths in the final generated set, since the likely load of such path is very small, such paths could be could be eliminated from ψ.

However, it should be appreciated that removing any particular path from ψ changes the probability p_{ψ} for every remaining path. More particularly, the probabilities of the remaining paths would be slightly increased. With this in mind, the objective of the path-determining device 140 can be to find the set of itineraries that has the fewest number of paths with expected load less than 1. In order to achieve this objective, the path-determining device 140 can employ the following approach:
(A) First order the paths of a market ψ as described in the text and equations above.
(B) Consider the first two paths p₁ and p₂, define ψ={1, 2} containing exactly these two paths, and then compute the probability of each, as

$$\begin{matrix}{p}_{1} = \frac{{ⅇ}^{V ( 1 )}}{{ⅇ}^{V ( 1 )} + {ⅇ}^{V ( 2 )}} , \\ {p}_{2} = \frac{{ⅇ}^{V ( 2 )}}{{ⅇ}^{V ( 1 )} + {ⅇ}^{V ( 2 )}} .\end{matrix} \qquad ( 8 )$$
where V(k) is the utility of path k.
(C) If Np₂<1 then stop, otherwise continue.
(D) Add the next path to the set, and re-compute the probabilities of each path in the new set. That is, add path k to ψ such that ψ={1, 2, . . . k}, and calculate

$$\begin{matrix}{p}_{1} = {ⅇ}^{V ( 1 )} / {\sum }_{i = 1}^{k} {ⅇ}^{V ( i )} , \\ {p}_{2} = {ⅇ}^{V ( 2 )} / {\sum }_{i = 1}^{k} {ⅇ}^{V ( i )} , \\ ⋮ \\ {p}_{k} = {ⅇ}^{V ( k )} / {\sum }_{i = 1}^{k} {ⅇ}^{V ( i )} .\end{matrix} \qquad ( 9 )$$
(E) If Npₖ<1, then stop. Otherwise, repeat step (D).

The inventors of the disclosed methods and systems have empirically discovered that the results of this particular stopping rule can be quite dramatic. For example, an itinerary set for the origin-destination market of Newark to Honolulu as derived under the simple stopping rule of comparing each path with a perfect non-stop is shown yielded over 5,000 paths. In contrast, using the most useful alternative stopping rule yielded a network of less than 50 paths.

The inventors of the disclosed methods and systems have also empirically discovered that significant efficiencies of computation may be gained if the number of stops term is broken into two components—intra-line stops and interline stops. Accordingly, the path-determining device 140 can take the form of a device capable of separately considering paths within a single travel service provider and/or separately considering paths utilizing multiple travel service providers.

Once the available itineraries/paths are generate by the path-determining device for all origin-destination market pairs, a database of these various paths for can be provided to the demand allocation device 150 where an unconstrained and/or constrained market allocation model for all origin-destination pairs in this database can be generated.

Market allocation generally refers to a process of allocating the demand in an origin-destination pair (a market) to the various alternative routes that serve that pair. For the purpose of this disclosure there are two related kinds of market allocation—unconstrained and constrained.

Unconstrained allocation refers to allocating passengers to flights without regard to the capacity constraints of the equipment flying those routes.

In contrast, constrained allocation takes those capacities into account. For example, an unconstrained model might predict that a particular leg of a trip might have over a thousand passengers flying in a single flight whereas a constrained model would limit the passenger count to the capacity of the aircraft used.

Market allocation can be closely tied with connection generation, especially when passenger choice models are considered. The exemplary demand allocation device 150 can determine the probability that a passenger in a given market will buy a ticket on a selected flight serving that market as a function of travel time, fare, departure and arrival times, number of stops, and so forth. The allocation of the number of passengers that would fly on a particular route, then, can be modeled as the product of that probability times the total demand for travel in that market. The unconstrained demand for a particular leg can then be described as the sum of the demands for that leg across each origin-destination path that uses the leg. That is, the unconstrained demand for an itinerary j, denoted by D(j), can be described according to EQ. 10 below:

$$\begin{matrix}D ( j ) = Pr [ j ] D \\ = \frac{D {ⅇ}^{V ( j )}}{{\sum }_{i ∈ Π} {ⅇ}^{V ( i )}} .\end{matrix} \qquad ( 10 )$$

where Pr[j] is the probability that a particular passenger will use itinerary j, D is the total demand across all itineraries serving an origin-destination pair, V(j) is the utility function associated with itinerary j (see, e.g., EQ. 1) and V(i) is the utility function associated with a particular itinerary i in a set of itineraries.

The total demand for a leg θ, written as D(θ) can then be expressed by EQ. 11 below:

$$D ( θ ) = {\sum }_{γ ∈ {Γ}_{θ}} {D}_{μ} {p}_{μ} ( γ ) . \qquad ( 11 )$$

where Γ_{θ} is the set of all paths that connect any market in the network that use leg θ, γ ε Γ_{θ} is a given path that serves a market μ ε M_{θ}(M_{θ} being the set of markets which use any useable path of a market), D_{μ} is the demand in that market and p_{μ}(γ) is the passenger choice probability of itinerary γ in market μ.

A particular issue to consider, of course, is that a particular leg connecting two airports may be a part of a number of itineraries connecting an array of origin-destination markets. The total demand on that leg can be the sum of the individual demand from each market using that leg up until the point where demand at that leg exceeds the capacity of the equipment used, where after the allocated demand destined for that leg must be reallocated to other flights. As using unconstrained demand models can lead to real scheduling problems, the exemplary demand allocation device 150 can alternatively use a more complex constrained allocation technique to resolve such problems.

In various embodiments, such reallocation can be done by reducing the demand for each market using the overcapacity leg to the point where the total allocated demand fits the capacity. The filled leg is then removed from the network, along with all paths that use it, and the remaining, unfulfilled demand is allocated to the reduced network. This process is repeated until there is no more demand to be allocated or until all eligible paths are used.

However, as mentioned above, there is a physical limit to the number of passengers that may be accommodated by a particular vehicle. Accordingly, demand on a particular travel leg is constrained by the capacity of that leg. If Θ is the set of legs in a network, and C_{θ} is the capacity of leg θ, then if D(θ)>C_{θ} for at least one leg θ, constrained demand will not match unconstrained demand. The allocation of constrained demand causes the network to change during the allocation process. As a result, the entire network may not available to all passengers, since some will find paths full when they come to book seats, and these must make a choice from a reduced set of choices. These issues are addressed by what is termed as the ZCF algorithm described below.

Under the assumption that booking rates are constant for all paths in all markets, capacity is reached when, for some number less than D(θ), say D*(θ), it is true that D*(θ)=C_{θ}. From EQ. 11, it is then the case that there must be values D*_{μ} for which:

$$\begin{matrix}{C}_{θ} = {D}^{*} ( θ ) \\ = {\sum }_{γ ∈ {Γ}_{θ}} {D}_{μ}^{*} {p}_{μ} ( γ )\end{matrix} \qquad ( 12 )$$

which is true if D*_{μ}=(C_{θ}/D(θ))D_{μ} since

$$\begin{matrix}{D}^{*} ( θ ) = {\sum }_{γ ∈ {Γ}_{θ}} {D}_{μ}^{*} {p}_{μ} ( γ ) \\ = {\sum }_{γ ∈ {Γ}_{θ}} \frac{{C}_{θ}}{D ( θ )} {D}_{μ} {p}_{μ} ( γ ) \\ = \frac{{C}_{θ}}{D ( θ )} {\sum }_{γ ∈ {Γ}_{θ}} {D}_{μ} {p}_{μ} ( γ ) \\ = {C}_{θ}\end{matrix} \qquad ( 13 )$$

This implies there will be a proportional reduction in the demand on each market using the leg, and thus supplies the basis for the ZCF algorithm. The pseudo-code specification of the ZCF can be expressed as follows:

For the Number of Legs in a Travel Network
(A) Find the leg in the network the most capacity in absolute numbers
(B) If no leg is over capacity then stop
(Cstart) For each market using the selected leg
   (C1) Calculate demand adjustment factors from Equation (13)
   (C2) Set demand in that market to the adjusted value
   (C3) Re-compute allocations to all itineraries in that market
(Cend) Next market
(D) Calculate allocations to all legs in network
(E) Remove all itineraries which use legs that are at capacity from network
(F) If no itineraries left in network, then end
(G) Set demand in all markets to original demand less adjusted demand

Repeat Steps A-G

The ZCF algorithm eliminates a major difficulty with constrained allocation algorithms. In particular, it should be appreciated that, with various other approaches, the outcome of an allocation can be different depending on the order in which over-capacity legs are adjusted, whereas the ZCF approach does not suffer from this problem.

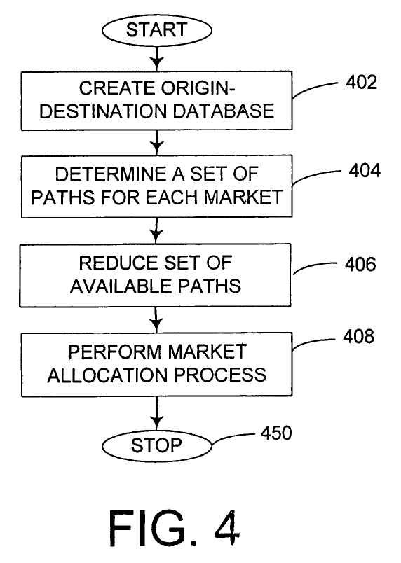

FIG. 4 is a flowchart outlining an exemplary operation according to the present disclosure for developing itineraries in a travel network. The process starts in step 402 where a database of origin-destination market pairs is created. Next, in step 404, a set of paths for each market is determined. Then, in step 606, the number of paths is reduced. In various embodiments, the manner of path reduction can take any number of forms. However, it should be appreciated that any or all of the passenger utility models described above and further below can be used to substantial advantage. Control continues to step 408.

In step 408, a market allocation process, which may include any of the constrained market allocation processes described above, can be performed on the reduced path set of steps 404 and 406 above to produce a constrained market model for the travel network. Control then continues to step 450 where the process stops.

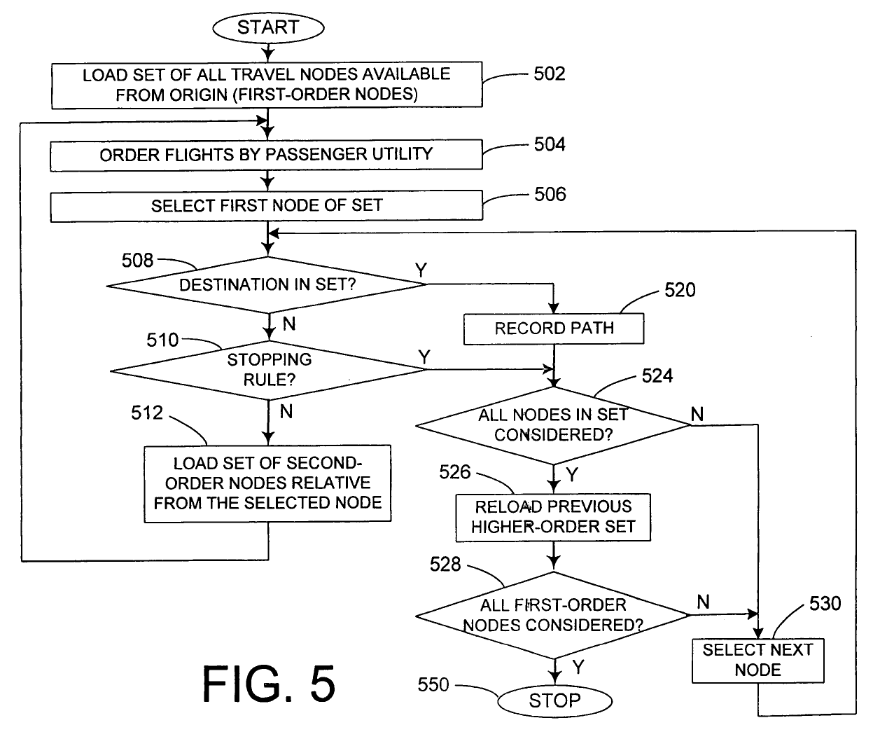

FIG. 5 is a flowchart outlining an exemplary operation according to the present disclosure for determining a set of paths for a particular origin-destination market pair, and is analogous in function to the pseudo-code listed above for the same purpose. The process starts in step 502 where a set of nodes that are directly accessible to the origin of the market pair are loaded, i.e., taken into consideration. Next, in step 504, the path legs are ordered according to passenger utility. Then, in step 506 the first node is taken into consideration. Control continues to step 508.

In step 508, a determination is made as to whether the node under consideration is a final destination node of the origin-destination pair. If the node is a destination, control jumps to step 520; otherwise, continues to step 510. In step 510, another determination is made as to whether a stopping rule is reached. In various embodiments, a stopping rule can include any and all of the stopping rules discussed above, including the passenger utility stopping rule described by EQS. 6-9 and related text. If a stopping rule is reached, control jumps to step 524; otherwise, control continues to step 512.

In step 512, a new set of lower-order nodes relative to the selected node is loaded, i.e., brought into consideration. By way of example and referring to FIG. 2, node E can be considered a first-order node, and node F and the destination node 220 can be considered secondary nodes relative to node E. Similarly, node G can be considered a lower-order (third-order) node to node F. Returning to FIG. 5, control then jumps back to step 504 where the newly loaded set of nodes is ordered according to passenger utility.

In step 520, which assumes that a destination node has been reached, the nodal path is recorded. Control continues to step 524.

In step 524, a determination is made as to whether all nodes in a set have been considered. If all nodes were considered, control continues to step 526; otherwise, control jumps to step 530.

In step 526, which assumes that all nodes in the present set of nodes have been considered, the previous, higher-order set of nodes is again loaded for consideration. Next, in step 528, a determination is made as to whether all first-order nodes have been considered. If all first-order nodes were considered, control continues to step 550 where the process stops; otherwise, control jumps to step 530.

In step 530, the next node in the set of nodes under consideration is brought into consideration, and control jumps back to step 508.

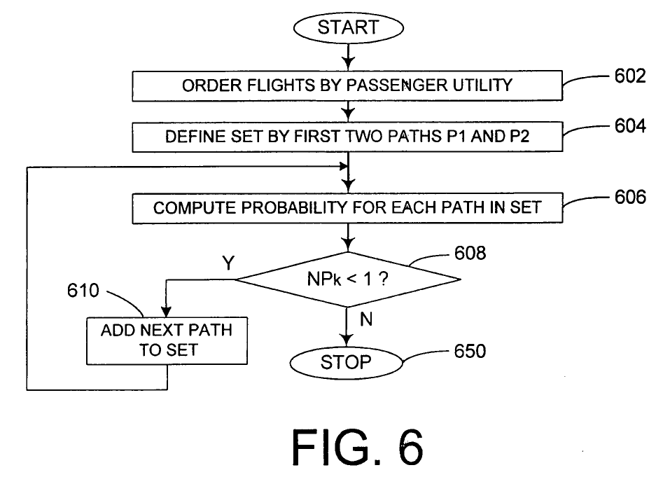

FIG. 6 is a flowchart outlining an exemplary operation according to the present disclosure for specifically applying the passenger utility model to a number of paths for an origin-destination market pair with the purpose of reducing the number of paths for consideration. The process starts in step 602 where the available flight paths are all ordered according to passenger utility per EQ. 7 above. Next, in step 604, the set of flight paths is defined by the first two paths, i.e., the first two paths (see EQ. 8 above) having the highest passenger utility. Control continues to step 606.

In step 606, the probability of each path above is computed. Next, in step 608, a determination is made as to whether NPₖ<1, i.e., whether the likelihood that a single passenger will use path k is less than 1. If NPₖ<1, control continues to step 65—where the process stops; otherwise, control continues to step 610.

In step 610, the next path having the highest passenger utility is added to the set of step 604. Control then jumps back to step 606 where the probability of each path above is again computed. The steps of 604-610 are then repeated until NPₖ<1 when the process stops at which time the available path set should include only those flights where a single passenger is likely.

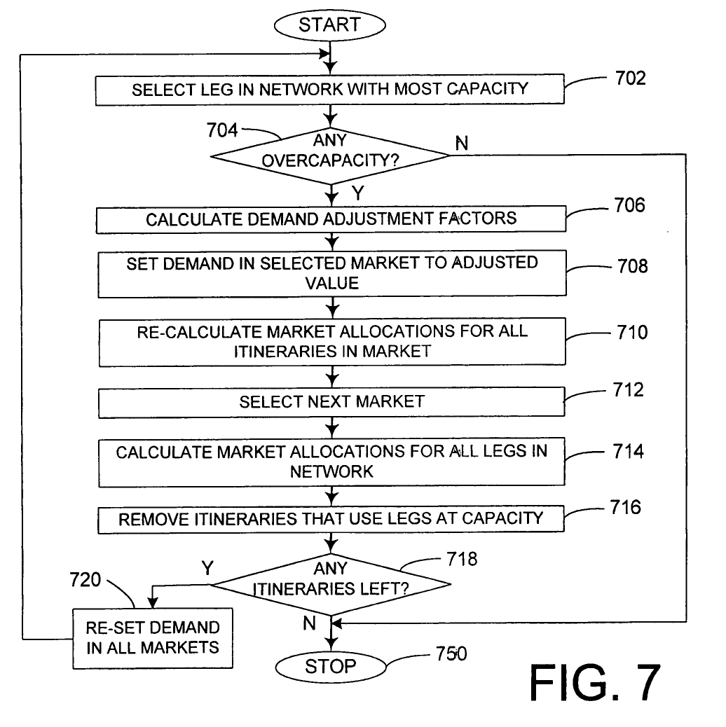

FIG. 7 is a flowchart outlining an exemplary operation according to the present disclosure for performing a constrained market allocation. The process starts in step 702 where the travel leg having the most capacity is selected. Next, in step 704, a determination is made as to whether the selected leg suffers from overcapacity. If the selected leg suffers from overcapacity, control continues to step 706; otherwise, control continues to step 750 where the process stops.

In step 706, for each origin-destination market pair using the selected leg, the relevant demand adjustment factors according to EQ. 13 above are calculated. Next, in step 708, the demand for each origin-destination market pair using the selected leg is set to the adjusted values computed in step 706. Then, in step 710, the market allocations for each origin-destination market pair using the selected leg is recalculated. Control then continues to step 714.

In step 714, the market allocations for all legs in the relevant travel network are re-calculated. Then, in step 716, those itineraries that use legs at capacity are removed from consideration for those legs. Control then continues to step 718.

In step 718, a determination is made as to whether any itineraries are left for consideration. If there are no itineraries left, control continues to step 750 where the process stops; otherwise, control jumps to step 720. In step 720 the demand for all markets is reset and control jumps back to step 702 where the next leg having the highest capacity is selected.

In various embodiments where the above-described systems and/or methods are implemented using a programmable device, such as a computer-based system or programmable logic, it should be appreciated that the above-described systems and methods can be implemented using any of various known or later developed programming languages, such as “C”, “C++”, “FORTRAN”, Pascal”, “VHDL” and the like.

Accordingly, various storage media, such as magnetic computer disks, optical disks, electronic memories and the like, can be prepared that can contain information that can direct a device, such as a computer, to implement the above-described systems and/or methods. Once an appropriate device has access to the information and programs contained on the storage media, the storage media can provide the information and programs to the device, thus enabling the device to perform the above-described systems and/or methods.

For example, if a computer disk containing appropriate materials, such as a source file, an object file, an executable file or the like, were provided to a computer, the computer could receive the information, appropriately configure itself and perform the functions of the various systems and methods outlined in the diagrams and flowcharts above to implement the various functions. That is, the computer could receive various portions of information from the disk relating to different elements of the above-described systems and/or methods, implement the individual systems and/or methods and coordinate the functions of the various disclosed systems and/or methods.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

### APPENDIX A

### Introduction to the Boeing Passenger Choice Model

R. Parker, BCA Marketing

Introduction

Much of the research underway in BCA Marketing today is focused on these two central goals:
Quantify the economic value to the passenger, the airline and Boeing of any proposed set of airplane features and technologies.
Develop methods and build tools that make value quantification fast, flexible, effective and rigorous.

Passenger preference is an essential concept in almost all quantitative analyses of airline networks. It determines the revenue potential of a particular route structure, and is a key aspect of network system profitability on which the financial health of an airline is ultimately based. The analysis of how Boeing products best amplify the revenue of the airline customer is not only one of reducing operating costs, but also of providing enhanced passenger safety and comfort, giving a competitive edge to the airline that uses Boeing products in its markets.

The ideal passenger choice model should be able to predict the share of the travel in a given city-pair market for each flight in that market at stipulated prices. That share should be derived as a function of properties of the flight, as well as the socioeconomic characteristics of the flying population. Flight properties include fare, speed, departure and arrival times, cabin, number of stops, airplane type, airline brand, etc. Among socioeconomic characteristics are willingness to pay, gender, background, and trip purpose.

Not only should we be able to compute share based on these attributes, but we should be able to calculate the trade-offs between them. For example, if two flights are competing in the same market, and new equipment allows one to fly faster, how much of a fare decrease is required of the other to offset the decrease in travel time and leave the market share for each the same? Further, if we can estimate the trade-offs, we can also judge the effect on share of a change in any attribute. For example, what's the difference in market share between a non-stop and a one-stop (or an interline one-stop vs. an intraline one-stop vs. a direct one-stop)?

In 2000, BCA Marketing undertook to upgrade and enhance its conceptual and mathematical models of airline passenger choice behavior, in response to increasing evidence that earlier models were inadequate for the analyses they were called upon to support. After 18 months of effort, much of it focused on the value of speed as part of the market analysis of the Sonic Cruiser, a new model has been developed and estimated. It addresses questions of market share and its relationships with attributes of choice such as those posed above. An introduction and overview of this model is presented in this technical memorandum.

The full derivation and description of the passenger choice model is quite lengthy, and is treated in a number of reports prepared for BCA Marketing by its consulting team1′ 2′ 3. The reader is referred to these reports for further details.
1 Bunch, D., Carson, R. and Louviere, J. The Boeing Decision Window Model [DWM]: Review, Analysis and Proposed Extensions. Technical Consultant Report #1: BCA Marketing, The Boeing Company, 2001.

2 Bunch, D., A Passenger Choice Utility Model Based on the Reanalysis of the HSCT Study Data. Technical Consultant Report #2: BCA Marketing, The Boeing Company, 2002.

3 Bunch, D., VTTS and VoS Analysis for HSCT and Boeing Internet Survey Data. Technical Consultant Report #3: BCA Marketing, The Boeing Company, 2002.

A Brief History

Passenger preference modeling has a long history at Boeing. The model in use prior to the development of this passenger choice model is referred to as the Decision Window Path Preference Model (DWM). No formal definition of that model is known, but three informal descriptions are available.4′ 5′ 6
4 Hopperstad, C. “Technical Discussion of the Decision Window Model,” Internal Slide Presentation, The Boeing Company, 1993.

5 A tutorial text for the Decision Window Model is offered in Decision Window Path Preference Methodology, BCA Marketing, The Boeing Company, 1996.

6 Baseler, R., “Airline Fleet Revenue Management—Design and Implementation” in Airline Economics, Aviation Week, 2002.

The Decision Window Model can be characterized as an elimination by aspects (EBA) model, based on an approach described by Tversky.7 Boeing's decision to pursue an EBA model was argued in a working paper by Thompson in 1984,8 and seems to have been based on some erroneous assumptions about the nature of the major alternative to EBA, random utility models. The passenger choice model discussed in this tech memo is a random utility formulation.
7 Tversky, A., “Elimination by Aspects: A Theory of Choice”, Psychology Review, 79: 281-299, 1972.

8 Thompson, C, “A Review of passenger Choice Models,” Working Paper, BCA Marketing, The Boeing Company, 1984.

Random utility models of discrete choice (where the number of things to choose from is finite) was explored by, among others, Luce and Suppes9. In the early 1970's a number of authors, most notably McFadden,10 (who won the 2001 Nobel Prize in economics for his work on the approach) formulated the current structure of a discrete choice model as we know them today. Ben-Akiva and Lehrman11 expanded the formulation to accommodate more complex structures. Anderson, de Palma and Thisse12 provided a lucid, rigorous treatment of product differentiation using the approach. Louvier, Hensher and Swaite13, Carson,14 and Bunch,15 are among other current authorities in the field. This last set of individuals make up the team which has worked with Boeing to formulate the choice model discussed here.
9 Luce. R. and Suppes, P, “Preference, Utility and Subjective Probability” in Luce, et al. Handbook of Mathematical Psychology, John Wiley, pp 249-410, 1965.

10 McFadden, D. “Econometric Models of Probabilistic Choice Among Products”, Journal of Business 53: 513-529, 1980.

11 Ben-Akiva, M and Lehrman, S, Discrete Choice Theory, MIT Press, 1985.

12 Anderson, S. P., de Palma, A. and Thisse, J: Discrete Choice Theory of Product Differentiation, MIT Press, 1992.

13 Louvier, J., Hensher, D., and Swait, J., Stated Choice Methods: Analysis and Applications, Cambridge, 2000.

14 See, for example, Carson, R. and Mitchell, R. “Sequencing and Nesting in Contingent Valuation Surveys,” Journal of Environmental Economics and Management, 28: 155-74, 1995.

15 See, for example, Bunch, D., “Estimability in the Multinomial Probit Model,” Transportation Research, 25(B)1. 1-12, 1991.

The Two-Choice Case

The random utility model is easiest to describe in the case of modeling the choice between only two alternatives. The formulation is readily extended to multiple choice situations, where the concepts are quite understandable, but the notation gets rather intense.

Suppose a passenger is presented with exactly two alternative flights between a given origin and destination. It is assumed that the passenger makes his selection based on a comparison of the attributes of each alternative-fare, departure and arrival times, number of stops, and so on. He evaluates the two options along these dimensions, and, based on how he values the characteristics of each, determines which he likes the best, and chooses it. A basic assumption of random utility is that every decision-maker executes such an evaluation, and behaves as though he determines a value, called the utility, of each alternative. The alternative with the highest utility is the one chosen.

If we could measure the utility an individual ascribes to each option, then we could predict what choice would be made. Psychologically, it seems reasonable to measure attributes of the choices (fare, stops, etc.) and characteristics of the decision-maker (age, gender, etc.) and somehow formulate a quantitative relationship between these factors and the choices made. We could, for example, use some kind of regression technique to estimate the utility. However, repeated psychological experiments have shown beyond any doubt that no matter how clever we are at mathematically describing the utility, people still don't make the correct choice according to our utility function specification. In other words, no matter how careful we are, there is still part of an individual's utility calculation that is not observable to us (or even known to the decision-maker, for that matter). This gives rise to the idea that individual utility consists of two parts—a known, observable part, and an unobservable, stochastic part. Thus we can never know exactly the choice a person will make, but rather only make statements about the probability of those choices.

To make this explicit, suppose we have a population A of individuals, each of which has a utility function Uᵢ(x), where x indicates one of the two choices facing individual i. Following the above discussion, we will assume that Uᵢ(x) consists of two parts, an observable part Vᵢ(x) and an unobservable, random part □ᵢ(x), and that the two pieces are related additively, i.e.
Uᵢ(x)=Vᵢ(x)+εᵢ(x) 1
for iε A, representing the population, and for x=1 and x=2, representing the two choices. We further assume that, while we know Vᵢ(x) completely, all we know about □ᵢ(x) is its probability distribution.

The two options differ from one another because of differences in their attributes (essentially by definition). For example, two flights may differ in fare. Therefore the utility must be a function of the levels of their attributes. Further, since individuals appreciate these attributes differently, and decision-makers are distinguished by differing values of a set of characteristics, the utility is also a function of the characteristics of the individual decision-makers. An example is cultural background, where European travelers tend to be less price sensitive than North American travellers. In general, the vector of characteristics of the decision-maker we will denote by wᵢ, and the vector of attributes of the alternatives by the vector yₓ. The two vectors can be related to one another through a vector-valued function we will call h, and we will write zᵢₓ=h(wᵢ,yₓ). Then we can rewrite equation 1 as
Uᵢ(zᵢₓ)=Vᵢ(zᵢₓ)+εᵢ(zᵢₓ) 2

The essential random utility calculation then goes like this: We know the observable part of the utility, but only know the probability distribution of the stochastic part. So, since choice 1 will be selected if Uᵢ(zᵢ₁) is greater than Uᵢ(zᵢ₂), we want to compute the probability that Uᵢ(zᵢ₁) is greater than Uᵢ(zᵢ₂), which is

$$\begin{matrix}Pr [ {U}_{i} ( {z}_{i1} ) \geq {U}_{i} ( {z}_{i2} ) ] = Pr [ {V}_{i} ( {z}_{i1} ) + {ɛ}_{i} ( {z}_{i1} ) \geq {V}_{i} ( {z}_{i2} ) + {ɛ}_{i} ( {z}_{i2} ) ] \\ = Pr [ {V}_{i} ( {z}_{i1} ) - {V}_{i} ( {z}_{i2} ) \geq {ɛ}_{i} ( {z}_{i2} ) - {ɛ}_{i} ( {z}_{i1} ) ] \\ = Pr [ {ɛ}_{i} ( {z}_{i2} ) - {ɛ}_{i} ( {z}_{i1} ) \leq {V}_{i} ( {z}_{i1} ) - {V}_{i} ( {z}_{i2} ) ] \\ = F ( {V}_{i} ( {z}_{i1} ) - {V}_{i} ( {z}_{i2} ) )\end{matrix} \qquad 3$$

where F is the probability distribution of εᵢ(zᵢ₂)−εᵢ(Zᵢ₂). We will write Pᵢ(j) for the probability that individual i chooses choice j.

The distribution of εᵢ(zᵢ₂)−εᵢ(zᵢ₁) is the subject of much discussion, and the literature on this subject is quite extensive. 16 A balance must be achieved between statistical validity, computational tractability, and data availability. If we assume that each of the □ᵢ(zᵢₓ) terms are independent and identically distributed for all i, then a reasonable choice for the distribution is the logistic distribution, which has distribution function G and density function g defined by
16 Any of the sources cited above will give an exhaustive treatment of this facet of the problem.

$$\begin{matrix}\begin{matrix}G ( {ɛ}_{i} ) = \frac{1}{1 + {ⅇ}^{- μ {ɛ}_{i}}} , & μ > 0 , & - ∞ < {ɛ}_{i} < ∞ ,\end{matrix} \\ g ( {ɛ}_{i} ) = \frac{μ {ⅇ}^{- μ {ɛ}_{i}}}{{( 1 + {ⅇ}^{- μ {ɛ}_{i}} )}^{2}} .\end{matrix} \qquad 4$$

Then we have

$$\begin{matrix}{P}_{i} ( 1 ) ≡ Pr [ {U}_{i} ( {z}_{i1} ) \geq {U}_{i} ( {z}_{i2} ) ] \\ = \frac{1}{1 + {ⅇ}^{- μ ( {V}_{i} ( {z}_{i1} ) - {V}_{i} ( {z}_{i2} ) )}} \\ = \frac{{ⅇ}^{μ {V}_{i} ( {z}_{i1} )}}{{ⅇ}^{μ {V}_{i} ( {z}_{i1} )} + {ⅇ}^{μ {V}_{i} ( {z}_{i2} )}} .\end{matrix} \qquad 5$$

This is the binary logit model.

Up to now, we have made no comment regarding the functional form of the observable part of the utility, Vᵢ(zₓ) . An operationally convenient form is that called linear in the parameters, wherein each element of z is related to V by an equation which has linear coefficients, e.g.

$$\begin{matrix}{V}_{i} ( {z}_{ij} ) = {\sum }_{k = 1}^{K} {β}_{k} {z}_{ijk} \\ = {β}^{T} {z}_{ij}\end{matrix} \qquad 6$$

for a vector of K coefficients □, where K is the number of members of z. It is important to point out that this formulation is linear only in the parameters, and that non-linear terms, such as products and logs, can and do appear as elements of Z.

With this structure, we can see how the probability of a choice is related to observable characteristics of the choice and chooser through the vector of variables z and vector of parameters □. The situation is precisely the same for the case of more than two choices, although the equations are not so tidy.

The Case of J Choices

Suppose the passenger is faced with not two, but an arbitrary number, say J>2, choices. As we did earlier, we assume that the choices and the decision-makers are characterized by a vector of variables zᵢⱼ for decision maker i and choice j. Each decision-maker has an associated real-valued function Uᵢ(zᵢⱼ):J→R¹ that assigns a utility for each choice by each decision-maker. The alternative with the highest value of Uᵢ is the choice made, that is, the value j* for which

$${U}_{i} ( {z}_{{ij}^{*}} ) = {max}_{j ∈ J} {U}_{i} ( {z}_{ij} ) \qquad 7$$

As before, U is assumed to be made up of two parts—a known, observable part and an unknown, stochastic part, but that the probability distribution of the stochastic utility component is known.

Following exactly the two-choice case, we first express Uᵢ(zᵢⱼ) as having observable and stochastic components:
Uᵢ(zᵢⱼ)=Vᵢ(zᵢⱼ)+εᵢ(zᵢⱼ) 8
where Vᵢ(zᵢⱼ) is the observable component and □ᵢ is the stochastic component. Following the form of equation 3, the probability that a particular alternative j* will be chosen by i is then

$$\begin{matrix}{P}_{i} ( {j}^{*} ) ≡ Pr [ {U}_{i} ( {z}_{{ij}^{*}} ) \geq {U}_{i} ( {z}_{ij} ) ; ∀ j ∈ J , j \neq {j}^{*} ] \\ = Pr [ {V}_{i} ( {z}_{{ij}^{*}} ) + {ɛ}_{{ij}^{*}} \geq {V}_{k} ( {z}_{ij} ) + {ɛ}_{ij} ; ∀ j ∈ J , j \neq {j}^{*} ] \\ = Pr [ {ɛ}_{ij} \leq {V}_{i} ( {z}_{{ij}^{*}} ) - {V}_{i} ( {z}_{ij} ) + {ɛ}_{{ij}^{*}} ; ∀ j ∈ J , j \neq {j}^{*} ] \\ = {\int }_{- ∞}^{{V}_{i} ( {z}_{{ij}^{*}} ) - {V}_{i} ( {z}_{i1} ) + {ɛ}_{i1}} … [ {\int }_{- ∞}^{{V}_{i} ( {z}_{{ij}^{*}} ) - {V}_{i} ( {z}_{{ij}^{*}} ) + {ɛ}_{{ij}^{*}}} ] … \times … \\ {\int }_{- ∞}^{{V}_{i} ( {z}_{iJ} ) - {V}_{i} ( {z}_{iJ} ) + {ɛ}_{iJ}} ⅆ F ( {ɛ}_{i1} , {ɛ}_{i2} , … [ {ɛ}_{{ij}^{*}} ] , … {ɛ}_{iJ} ]\end{matrix} \qquad 9$$

where F(εᵢ₁,εᵢ₂, . . . εᵢⱼ) is the joint probability distribution function of the stochastic terms in the J utility functions associated with i, and the notation [•]indicates that the enclosed term is omitted.

The structure of F(εᵢⱼ,εᵢ₂, . . . εᵢⱼ) is the subject of much research. In practice, because of the considerable computational difficulty, only one approach has yet yielded significant results. (But important recent results17 are making other avenues of attack more tractable.) First of all let's define the extreme value type one distribution by means of
17 Train, K, Discrete Choice Methods with Simulation, Cambridge, 2003.

G(ε)=exp[−e^{-μ(ε-η)}],μ>0
g(ε)=μe^{-μ(ε-η)}exp[−e^{-μ(ε-η)}], 10
with location parameter □ and scale parameter □. This probability distribution is also referred to as the Gumbel or double exponential. Its mode is □, the mean is □ □ □, where □ is Euler's constant, and the variance is □^{□} □□^{□}. The extreme type one is also preserved over linear transformations. But most importantly for random utility models, the difference of two independent random variables with extreme value type one distributions and identical scale parameters has a logistic distribution, exactly like the two choice case.

Now, assume that for all iε A the □ᵢⱼ are independent and identically distributed as a extreme type one distribution with common location parameter □ (which, without loss of generality, can beset to zero) and common scale parameter □. Then it can be shown18 that
18 Ben-Akiva and Lehnnan, op cit, p 106.

$${P}_{i} ( {j}^{*} ) = \frac{{ⅇ}^{μ {V}_{i} ( {z}_{{ij}^{*}} )}}{{\sum }_{j ∈ J} {ⅇ}^{μ {V}_{i} ( {z}_{ij} )}} \qquad 11$$

which is exactly analogous to equation 5 for more than two choices. This is the multinomial logit model (MNL).

Since □ is constant for all terms in equation 11, and is not identifiable in the model, it is customary to assume □ □ □. However, the homoscedasticity property this implies can be difficult to justify in practice, so techniques such as nested logit have been developed which deal with such issues. We will not explore such complexities in this discussion, but advanced forms of the passenger choice model include application of these techniques.

As with the binary logit, we will also assume that Vᵢ(zᵢⱼ) is linear in its parameters, and so

$${V}_{i} ( {z}_{ij} ) = {β}^{T} {z}_{ij} = {\sum }_{k = 1}^{K} {β}_{k} {z}_{ijk} . Then {P}_{i} ( {j}^{*} ) is \\ {P}_{i} ( {j}^{*} ) = \frac{{ⅇ}^{{β}^{T} {z}_{{ij}^{*}}}}{{\sum }_{j = 1}^{J} {ⅇ}^{{β}^{T} {z}_{ij}}} \qquad 12$$

Properties of the Multinomial Logit

The MNL has some properties which are very attractive for our purposes. In particular, the market share which will choose a particular flight option is directly computable, and is a function of the characteristics and attributes described by the observable utility function V. In addition, the point elasticity of the probability with respect to any variable in V is easily calculated, and there are relatively direct expressions for incremental probability. Specifically,
1. Market share. The number of passengers who will choose flight choice j is given by the expected value of choosing j summed across all individuals in the population. This is, where N is the number of individuals in A,

$$\begin{matrix}M ( j ) = {\sum }_{i ∈ A} {P}_{i} ( j ) \\ = \frac{{\sum }_{i ∈ A} {ⅇ}^{{β}^{T} {z}_{ij}}}{{\sum }_{s = 1}^{J} {ⅇ}^{{β}^{T} {z}_{is}}}\end{matrix} \qquad 13$$

If the population is homogeneous with respect to the characteristics that appear in z, then this reduces to simply the common probability of j times the number of individuals in the population:
M(j)=NP(j),P(j)=Pᵢ(j),∀iε A. 14
2. Elasticity. The (point) elasticity of Pᵢ(j) with respect to any variable zᵢⱼₖ in zᵢⱼ is, by definition,

$$\begin{matrix}{E}_{{z}_{ijk}}^{{P}_{i} ( j )} = \frac{\partial {P}_{i} ( j )}{\partial {z}_{ijk}} \cdot \frac{{z}_{ijk}}{{P}_{i} ( j )} \\ = ( 1 - {P}_{i} ( j ) ) {z}_{ijk} \frac{\partial {V}_{i} ( j )}{\partial {z}_{ijk}}\end{matrix} \qquad 15$$

This permits the calculation of the changes in market share per unit change in any variable in the observed utility function V, which is very important in assessing the impacts of proposed changes in the attributes of the alternatives. For example, we can compute the unit change in share as a function of changes in speed or fare.
3. New or dropped alternatives. The MNL has another valuable property which greatly simplifies its use in various analytic settings. If an alternative j ε J is dropped from (or added to) the set of alternatives, then the increase (or decrease) in the probability of choosing another, different alternative j is proportional to the probability of choosing j when j* was (or was not) in the choice set. Explicitly, if J−{j*} represents J without j*, and P_{A}(j) is the probability of choosing j from the choice set A, then

$$\begin{matrix}{P}_{J - \{ {j}^{*} \}} ( j ) = Θ {P}_{J} ( j ) , & 16 \\ where & \\ Θ = \frac{{\sum }_{k ∈ J} {ⅇ}^{V ( k )}}{{\sum }_{k \neq {j}^{*}} {ⅇ}^{V ( k )}} . & 17\end{matrix}$$

This fact is useful, for example, in path generation algorithms.
4. Change in utilities. If the observed utility changes, then the MNL allows easy recalculation of the resulting probabilities. Suppose the V(j) change to \overline{V}(j), and write \overline{P}(j) for the probability of the alternative j under the changed utility. Then

$$\overline{P} ( j ) = \frac{P ( j ) {ⅇ}^{Δ V ( j )}}{{\sum }_{k ∈ J} P ( k ) {ⅇ}^{Δ V ( k )}} \qquad 18$$

with ΔV(j)=V(j)−\overline{V}(j). This is called the incremental MNL, and says that the new choice probabilities can be obtained directly from the old choice probabilities and the differences in the observed utilities.
The Independence of Irrelevant Alternatives

The major attraction of the multinomial logit is its (relative) ease of calculation. It has a number of significant drawbacks, however, and much research has been done to overcome or circumvent these disadvantages. Detailed exploration of these questions is beyond the scope of this discussion, but mention should be made of a major implication of the model which is often cited as a fatal flaw. The MNL as described above implies a property referred to as the Independence of Irrelevant Alternatives, or IIA. This property states that for a given decision-maker, the ratio of the choice probabilities of any two alternatives is completely independent of the choice probabilities of any other alternatives. This characteristic of MNL models is innocent enough, but it leads to the some strange anomalies such as the “red bus-blue bus problem.” A number of techniques have been developed to overcome the restrictiveness of the IIA property, most particularly the nested logit model.19 We will be using nested logit in the advanced development of the Boeing passenger choice model. That formulation will be discussed in detail when the model extension is completed.
19 For example, see Chapter 10 of Ben-Akiva and Lehrman, op. cit.

The Basic Passenger Choice “High Resolution” Model

The parameters for the observable portion of the utility Vᵢ(zᵢⱼ) are estimated from statistical analyses of choice data, either gathered from direct observation, called revealed preference data, or from specially designed surveys called choice experiments, which are examples of stated preference data. There has been a long-standing debate of the validity of stated preference choice data,20 but the reality is that many choices cannot be studied using revealed preference observations, and we have no alternative but to use stated preference. Boeing has participated in and continues to sponsor passenger stated preference choice research and analysis, especially with the recent explorations of higher-speed aircraft such as the Sonic Cruiser.21′ 22′ 23
20 Louviere, J, et al. op cit. pp 227ff.

21 Bunch, Carson, Louviere, op. cit.

22 Bunch, Technical Consultant Report #2, op. cit.

23 Bunch, Technical Consultant Report #3, op. cit.

The decision-maker in the our context is the entity buying a ticket on a particular flight. That entity is usually an individual, but can be a more complex organization such as a corporate travel office or group booking service. The booking entity can also purchase more than one ticket, but it is assumed that the decision structure is independent of the number of tickets purchased.24 The choice set from which the tickets are selected is not simply a list of flights, but rather the set of fare classes on the set of flights that are available. A fare
24 This is clearly not true, say in the case of an individual purchasing vacation tickets for his family. However, data to establish this dependency is not yet available, so independence is assumed. class is a seat offered at a price distinct from other prices. It has specific attributes of fare, of course, and airplane cabin.

The result of the research done by Boeing to date has produced the following equation, which is used in conjunction with equation 12 to estimate the probability of choice for a path jε J

$${V}_{i} ( j ) = {β}^{T} {z}_{ij} = {[ \begin{matrix}{β}_{f} \\ {β}_{d} \\ {β}_{db} \\ {β}_{s} \\ {β}_{ec} \\ {β}_{1 st} \\ {β}_{mdi} \\ {β}_{mai} \\ {β}_{mdo} \\ {β}_{mao} \\ {β}_{edi} \\ {β}_{eai} \\ {β}_{edo} \\ {β}_{eao} \\ {β}_{25} \\ {β}_{100} \\ {β}_{St} \\ {β}_{Eu} \\ {β}_{Fe} \\ {β}_{Oz} \\ {β}_{1 –6} \\ {β}_{7 –10} \\ {β}_{ecEu}\end{matrix} ]}^{T} [ \begin{matrix}ln {f}_{j} \\ {d}_{j} \\ {d}_{j} ln {d}_{b} \\ {S}_{j} \\ {X}_{ec , j} \\ {X}_{1 st , j} \\ {X}_{mdi , j} \\ {X}_{mai , j} \\ {X}_{mdo , j} \\ {X}_{mao , j} \\ {X}_{edi , j} \\ {X}_{eai , j} \\ {X}_{edo , j} \\ {X}_{eao , j} \\ {X}_{25 , i} ln {f}_{j} \\ {X}_{100 , i} ln {f}_{j} \\ {X}_{St , i} ln {f}_{j} \\ {X}_{Eu , i} ln {f}_{j} \\ {X}_{Fe , i} ln {f}_{j} \\ {X}_{Oz , i} ln {f}_{j} \\ {d}_{j} {X}_{1 –6 , i} \\ {d}_{j} {X}_{7 –10 , i} \\ {X}_{ec , j} {X}_{Eu , i}\end{matrix} ] \qquad 19$$

The β coefficients, of course, are estimated from research data. The variables are defined as follows (which, collectively, form the matrix z).

Attributes of the Flight/Fare Class Choice:
fⱼ=the fare for fare class j,
dⱼ=the duration of the flight on which j is available,
d_{b}=the base duration of the market, which is defined to be the shortest travel time using existing equipment and route configurations,
Sⱼ=number of stops in the flight on which j is available,
X_{mdi,j}=1 if the flight is an inbound morning departure (between 6 AM and noon), 0 otherwise,
X_{mai,j}=1 if an inbound morning arrival, 0 otherwise,
X_{mdo,j}=1 if an outbound morning departure, 0 otherwise,
X_{mao,j}=1 if an outbound morning arrival, 0 otherwise,
X_{edi,j}=1 if an inbound evening departure (from 6 PM to midnight), 0 otherwise,
X_{eai,j}=1 if an inbound evening arrival, 0 otherwise,
X_{edo,j}=1 if an outbound evening departure, 0 otherwise,
X_{eao,j}=1 if an outbound evening arrival, 0 otherwise,
X_{1st,j}=1 if the fare class is in a first class cabin, 0 otherwise,
X_{ec,j}=1 if the fare class in is an economy cabin, 0 otherwise.

Attributes of the passenger making the choice:
X_{25,i}=1 if income is less than 25 k/year for passenger i, 0 otherwise,
X_{100,i}=1 if the income is more than 100 k/year for passenger i,
X_{St,i}=1 if passenger k is a student, 0 otherwise,
X_{eu,i}=1 if passenger k is of European background, 0 otherwise,
X_{fe,i}=1 if passenger k is of Far Eastern background,
X_{oz,}i =1 if passenger k is of Australian background,
X_{1-6,i}=1 if total journey is from 1 to 6 days in duration,
X_{7-1,i}=1 if total journey is from 7 to 10 days in duration.

The variables represented by the X's have values of 0 or 1, and are often called indicator variables. They represent categorized data, such as the case of departure and arrival time, and often two or more are used to provide a sort of “binary number indication” of which category is being referenced When multiple variables are used in this way, the case where all related indicators are 0 is the base case. In the example of the arrival times, zeros for both indicators means the arrival time is in the base case, which is afternoon (between noon and 6 PM).25
25 For readers unfamiliar with the use of indicator variables in regression analysis, consult Neter, J, Wasserman, W. and Kutner, M., Applied Linear Regression Models, 2^{nd} Ed., Irwin, 1989, pp 349-351.

As is often found in linear regression, note that several terms in the model are combinations of simpler terms, as for example the duration times log (base duration) term. These are referred to as interaction terms, where two (or more) variables are mathematically connected in a special way, reflecting the interaction between the two variables. It is typical of these models that passenger characteristics enter the model through such interaction terms.

It should be noted that the “stops” term in the model does not account for the time added to a flight because of the stop. This is incorporated into the trip duration terms of the model.

There is some theoretical justification for this model formulation in addition to the results of empirical analysis. Bunch26 has reported some fundamental work wherein this model form is deduced from consideration of a more basic micro-econometric analysis for the leisure traveler. We are now investigating a similar deductive relationship for the business trip purpose.
26 Bunch, D. “Behavioral Models and Eslimates for Leisure-Passenger Value of Travel-Time Savings in Long-Haul Air Travel Markets Using Stated Choice Experiments”, Journal of Transportation Economics and Policy, under review, 2003.

The “Low Resolution” Passenger Choice Model

The model discussed previously is referred to as high resolution because of the level of detail about the socioeconomic characteristics of the decision-maker evident in it. In practice, data to support that degree of detail is often not available, so a simplified model, the low resolution model, is used. For the sake of future reference, we will use the notation Vᵢ^{H}(j) to represent the high resolution model, and Vᵢ^{H}(j) to represent the low resolution expression, if and when the distinction is necessary.

The low resolution model is simply

$$\begin{matrix}{V}_{i}^{L} ( j ) = {[ \begin{matrix}{ϕ}_{f} \\ {ϕ}_{d} \\ {ϕ}_{db} \\ {ϕ}_{s} \\ {ϕ}_{ec} \\ {ϕ}_{1 st} \\ {ϕ}_{md} \\ {ϕ}_{ma} \\ {ϕ}_{ed} \\ {ϕ}_{eao}\end{matrix} ]}^{T} [ \begin{matrix}ln {f}_{j} \\ {d}_{j} \\ {d}_{j} ln {d}_{b} \\ {S}_{j} \\ {X}_{ec , j} \\ {X}_{1 st , j} \\ {X}_{md , j} \\ {X}_{ma , j} \\ {X}_{ed , j} \\ {X}_{ea , j}\end{matrix} ] \\ = {φ}^{T} z \\ = {\sum }_{k = 1}^{10} {ϕ}_{k} {z}_{k}\end{matrix} \qquad 20$$

Structurally, the low resolution model has all the terms of the high resolution model of equation 19 less all the terms which contain demographic or socioeconomic variables, such as income, and employing a simplified set of coefficients for time of day, which ignore inbound and outbound distinctions. Specifically, these are
X_{md,j}=1 if the flight is an morning departure (between 6 AM and noon), 0 otherwise,
X_{ma,j}=1 if a morning arrival, 0 otherwise,
X_{ed,j}=1 if an evening departure, 0 otherwise,
X_{ea,j}=1 if an evening arrival, 0 otherwise,

We use φ to designate the parameter set in this model because they are generally different then the corresponding parameters in the high resolution case, insofar as some of the variation explained by the inclusion of the demographic variables is lost in the low resolution model, but is “absorbed” into the coefficient estimates for the remaining attribute variables.

Estimated Values of the Parameter Vectors

The parameter vectors, □ for the high resolution model and φ for the low resolution model, have been estimated as a result of several research efforts by Boeing in the last two years. The values of these estimates are Boeing Proprietary, so are not included in this discussion. Individuals or organizations which have the authority to see and use these coefficient values can refer to Tech Memo #9 (R. A. Parker, BCA Marketing, June, 2003), which contains the current values of the parameters. Revisions to this Tech Memo will be issued periodically with updated, more refined estimates.

Fare and Speed Elasticity and Market Share for the Low Resolution Model

To illustrate how the models can be used, here are the elasticity values for the fare and speed (duration) variables in the low resolution model. Recalling equation 15, we can calculate these as follows: For fare,

$$\begin{matrix}{E}_{{f}_{j}}^{P ( j )} = ( 1 - P ( j ) ) {f}_{j} \frac{\partial {V}_{i} ( j )}{\partial {f}_{j}} \\ = \frac{\partial {φ}^{T} z}{\partial {f}_{j}} \\ = ( 1 - P ( j ) ) {f}_{j} \frac{d {ϕ}_{f} ln {f}_{j}}{{df}_{j}} \\ = {ϕ}_{f} ( 1 - P ( j ) ) ,\end{matrix} \qquad 21$$

and for duration,

$$\begin{matrix}{E}_{{d}_{j}}^{P ( j )} = ( 1 - P ( j ) ) {d}_{j} \frac{d {ϕ}_{d} {d}_{j} ln {d}_{b}}{d {d}_{j}} \\ = {ϕ}_{f} ln {d}_{b} ( 1 - P ( j ) ) .\end{matrix} \qquad 22$$

Equation 18 is useful in calculating the changes in market share due to incremental changes in fare or trip duration. Suppose fare fⱼ is changed to \overline{f}ⱼ, then we have

$$\begin{matrix}Δ V ( j ) = V ( \overline{j} ) - V ( j ) \\ = ( {β}_{f} ln {\overline{f}}_{j} + Q ) - ( {β}_{f} ln {f}_{j} + Q ) \\ = {β}_{f} ( ln {\overline{f}}_{j} - ln {f}_{j} )\end{matrix} \qquad 23$$

where Q is the remainder of the terms of the model. Assume none of the other fares change except the one for choice j, then for all k not equal to j, ΔV(k)is equal to zero, and we have

$$\begin{matrix}\overline{P} ( j ) = \frac{P ( j ) {ⅇ}^{Δ V ( j )}}{{\sum }_{k ∈ J} P ( k ) {ⅇ}^{Δ V ( k )}} \\ = \frac{P ( j ) {ⅇ}^{V ( \overline{j} ) - V ( j )}}{{\sum }_{k ∈ J} P ( k ) {ⅇ}^{V ( \overline{k} ) - V ( k )}} \\ = \frac{P ( j ) {ⅇ}^{{β}_{f} ( ln {\overline{f}}_{j} - ln {f}_{j} )}}{P ( j ) {ⅇ}^{{β}_{f} ( ln {\overline{f}}_{j} - ln {f}_{j} )} + {\sum }_{k \neq j} P ( k )} \\ = \frac{P ( j ) {ⅇ}^{{β}_{f} ( ln {\overline{f}}_{j} - ln {f}_{j} )}}{P ( j ) ( {ⅇ}^{{β}_{f} ( ln {\overline{f}}_{j} - ln {f}_{j} )} - 1 ) + 1} .\end{matrix} \qquad 24$$

The new market share resulting from a change in a single fare is thus simply N\overline{P}(j).

Similarly, for a change from duration dⱼ to \overline{d}ⱼ for alternative j, the probability changes to

$$\overline{P} ( j ) = \frac{P ( j ) {ⅇ}^{( {β}_{d} + {β}_{db} ln {d}_{b} ) ( {\overline{d}}_{j} - {d}_{j} )}}{P ( j ) ( {ⅇ}^{( {β}_{d} + {β}_{db} ln {d}_{b} ) ( {\overline{d}}_{j} - {d}_{j} )} - 1 ) + 1} . \qquad 25$$

with the corresponding implied change to market share.
Footnotes
1 Bunch, D., Carson, R. and Louviere, J. The Boeing Decision Window Model [DWM]: Review, Analysis and Proposed Extensions. Technical Consultant Report #1: BCA Marketing, The Boeing Company, 2001.
2. Bunch, D., A Passenger Choice Utility Model Based on the Reanalysis of the HSCT Study Data. Technical Consultant Report #2: BCA Marketing, The Boeing Company, 2002.
3. Bunch, D., VTTS and VoS Analysis for HSCT and Boeing Internet Survey Data. Technical Consultant Report #3: BCA Marketing, The Boeing Company, 2002.
4. Hopperstad, C. “Technical Discussion of the Decision Window Model,” Internal Slide Presentation, The Boeing Company, 1993.
5. A tutorial text for the Decision Window Model is offered in Decision Window Path Preference Methodology, BCA Marketing, The Boeing Company, 1996.
6. Baseler, R., “Airline Fleet Revenue Management—Design and Implementation” in Airline Economics, Aviation Week, 2002.
7. Tversky, A., “Elimination by Aspects: A Theory of Choice”, Psychology Review, 79: 281-299, 1972.
8. Thompson, C, “A Review of passenger Choice Models,” Working Paper, BCA Marketing, The Boeing Company, 1984.
9. Luce. R. and Suppes, P, “Preference, Utility and Subjective Probability” in Luce, et al. Handbook of Mathematical Psychology, John Wiley, pp 249-410, 1965.
10. McFadden, D. “Econometric Models of Probabilistic Choice Among Products”, Journal of Business 53: 513-529, 1980.
11. Ben-Akiva, M and Lehrman, S, Discrete Choice Theory, MIT Press, 1985.
12. Anderson, S. P., de Palma, A. and Thisse, J: Discrete Choice Theory of Product Differentiation, MIT Press, 1992.
13. Louvier, J., Hensher, D., and Swait, J., Stated Choice Methods: Analysis and Applications, Cambridge, 2000.
14. See, for example, Carson, R. and Mitchell, R. “Sequencing and Nesting in Contingent Valuation Surveys,” Journal of Environmental Economics and Management, 28: 155-74, 1995.
15. See, for example, Bunch, D., “Estimability in the Multinomial Probit Model,” Transportation Research, 25(B)1. 1-12, 1991.
16. Any of the sources cited above will give an exhaustive treatment of this facet of the problem.
17. Train, K, Discrete Choice Methods with Simulation, Cambridge, 2003.
18. Ben-Akiva and Lehrman, op cit, p 106.
19. For example, see Chapter 10 of Ben-Akiva and Lehrman, op. cit.
20. Louviere, J, et al. op cit. pp 227ff.
21. Bunch, Carson, Louviere, op. cit.
22. Bunch, Technical Consultant Report #2, op. cit.
23. Bunch, Technical Consultant Report #3, op. cit.
24. This is clearly not true, say in the case of an individual purchasing vacation tickets for his family. However, data to establish this dependency is not yet available, so independence is assumed.
25. For readers unfamiliar with the use of indicator variables in regression analysis, consult Neter, J, Wasserman, W. and Kutner, M., Applied Linear Regression Models, 2^{nd} Ed., Irwin, 1989, pp 349-351.
26. Bunch, D. “Behavioral Models and Estimates for Leisure-Passenger Value of Travel-Time Savings in Long-Haul Air Travel Markets Using Stated Choice Experiments”, Journal of Transportation Economics and Policy, under review, 2003.

What is claimed is:

1. A computer-based apparatus for determining constrained market allocation for a travel network having a plurality of origin-destination market pairs, comprising:
a first device that computes constrained market allocation based on the capacity of at least a first leg of the travel network and the passenger utility of at least one path that includes the first leg.

2. The apparatus of claim 1, wherein the first device further computes market allocation based on a demand of the first leg.

3. The apparatus of claim 2, wherein the first device further computes market allocation based on a most useful alternative approach.

4. The apparatus of claim 2, wherein the first device computes market allocation based on a majority of legs in the travel network, the demand of each of the majority of legs and the capacity of each of the majority of legs.

5. The apparatus of claim 1, wherein the first device computes market allocation based on a majority of legs in the travel network, the demand of each of the majority of legs and the capacity of each of the majority of legs.

6. A method for performing a constrained market allocation on a travel network having a plurality of origin-destination market pairs and wherein at least two origin-destination market pairs share a first common travel leg, comprising:
determining whether the first leg is over capacity; and
if the first leg is over capacity, performing the step of calculating demand adjustment factors for each market pair sharing the first leg to produce an adjusted value for the first leg.

7. The method of claim 6, further comprising performing the step of setting demand in the first leg to the adjusted value.

8. The method of claim 7, further comprising performing the step of re-computing market allocations for all itineraries scheduled to use the first leg.

9. The method of claim 6, further comprising the step of calculating market allocations for all legs in network.

10. The method of claim 9, further comprising removing from the network all itineraries that use at least one leg that is at capacity.

11. The method of claim 9, further comprising setting demand for at least one market pair to the pair's original demand less a respective adjusted demand.

12. A method for determining a number of potential paths for an origin-destination market pair in a travel network, comprising: p1 forming a set of first paths based on the passenger utility of the first paths.

13. The method of claim 12, wherein the set of first paths includes at least two first paths having the highest passenger utility among the available paths.

14. The method of claim 12, wherein forming the set of first paths includes computing the passenger utility of the first path having the lowest probability.

15. The method of claim 14, wherein forming the set of first paths further includes computing the likelihood of use of the path having the lowest probability, a likelihood of use being defined as the product of a probability of path use and the number of itineraries of an origin-destination pair.

16. The method of claim 15, further comprising adding a second path to the set of first paths if the computed likelihood of use is less that a predetermined limit.

17. The method of claim 15, further comprising adding a second path to the set of first paths if the computed likelihood of use is less that a predetermined limit.

18. The method of claim 17, wherein the predetermined limit is one or close to one.

19. A method for determining a set of desirable paths for an origin-destination market pair in a travel network, comprising:
forming a set of initial paths from a set of available paths for the origin-destination market pair, wherein the set of initial paths includes only two paths having the highest passenger utility of any of the available paths.

20. The method of claim 19, further comprising computing the probability of use of each path based on the formula:
$${p}_{1} = \frac{{ⅇ}^{V ( 1 )}}{{ⅇ}^{V ( 1 )} + {ⅇ}^{V ( 2 )}} , \\ {p}_{2} = \frac{{ⅇ}^{V ( 2 )}}{{ⅇ}^{V ( 1 )} + {ⅇ}^{V ( 2 )}} .$$
where p₁ and p₂ are the probability of use for the two initial paths, V(1) is the passenger utility of the first of the two initial path and V(2) is the passenger utility of the second of the two initial path.

21. The method of claim 19, further comprising adding a third path to the set of initial paths if the likelihood of use for both of the initial two paths exceeds a predetermined limit.
